(19) United States
(12) Patent Application Publication
(10) Pub. No.: US 2008/0024866 A1
(43) Pub. Date: Jan. 31, 2008

(54) Zero-order diffractive filter

(76) Inventors: Harald Walter, Kilchberg (CH); Gilbert Gugler, Marly (CH); Alexander Stuck, Wettingen (CH); Marc Pauchard, Fribourg (CH); Robert Beer, Marly (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/827,143

(22) Filed: Jul. 10, 2007

(30) Foreign Application Priority Data
Jul. 28, 2006 (EP) EP 06015757

(51) Int. Cl. G02B 27/44; B32B 27/28; G02B 5/18

(52) U.S. Cl. 359/569; 428/824.5; 977/892; 977/950

(57) ABSTRACT

The present invention relates to Zero-order Diffractive filters (ZOFs), comprising a first layer having periodic diffractive microstructures and a second layer, wherein said first layer has a refractive index higher than said second layer by at least 0.2, and nanoparticles located in at least one of said layers which affect the refractive index of said at least one of said layers. The present invention further relates to methods of manufacturing such ZOFs, to the use such ZOFs e.g. in security devices and to the use of specific materials for manufacturing ZOFs.

The present invention relates to Zero-order Diffractive filters (ZOFs), to methods of manufacturing them, to the use of ZOFs and to the use of specific materials for manufacturing ZOFs.

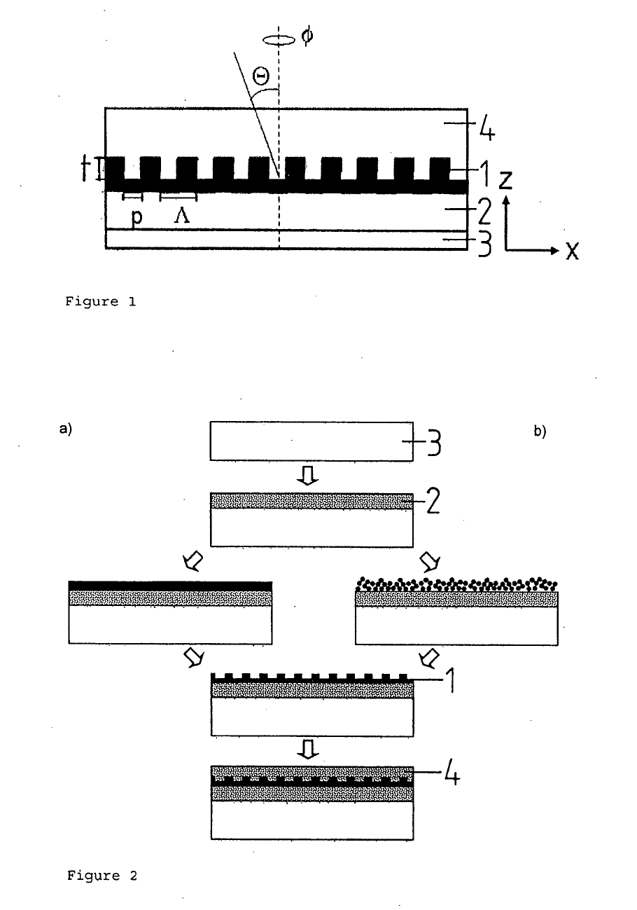

ZOFs (sometimes called resonant gratings) are well known and described e.g. in D. Rosenblatt et al, “Resonant Grating Waveguide Structures” IEEE Journal of Quantum Electronics 33, 1997, p. 2038-2059 and M. T. Gale, “Zero-Order Grating Microstructures” in R. L. van Renesse, Optical Document Security, 2nd Ed., pp. 267-287. Typically, ZOFs are made of a waveguiding layer having diffractive microstructures with a period that is usually smaller than the wavelength of light (see FIG. 1). Examples of such microstructures are parallel or crossed grating lines. The waveguiding layer is made of a material with relatively high refractive index n_{high} surrounded by material with lower refractive index n_{low}≦n_{high}. The materials surrounding the waveguide can have different indices of refraction. The micro-structured, high-refractive index layer acts as a leaky waveguide (“waveguiding layer”). Such ZOFs, when illuminated by polarised or unpolarised polychromatic visible light, are capable of separating zero diffraction order output light from higher diffraction order output light. A part of the incident light is directly transmitted and a part is diffracted and then trapped in the waveguiding layer. Some of the trapped light is rediffracted out such that it interferes with the transmitted part. At a certain wavelength and angular orientation a resonance occurs which leads to complete destructive interference. No such light is transmitted. Thus, ZOFs possess characteristic reflection and transmission spectra depending inter alia on the viewing angle and the orientation of the grating lines with respect to the observer. Parameters influencing the colour effect are, for example, the period Λ, the thickness c of the high refractive index layer, the grating depth t, the fill factor (or duty cycle) f.f.=p/Λ, the shape of the microstructure (e.g. rectangular, sinusoidal, triangular or more complex) and the indices of refraction of the materials (see FIG. 1). The waveguiding layer, as well as any further layer coming into contact at least with the incoming light the layers adjacent thereto have to be substantially transparent (which means transmission T>50%, preferably T>90%) at least in a part of the visible spectral range. The period Λ is preferably in the range of 100 nm to 1000 nm, typically between 300 nm to 500 nm (“sub wavelength structure”). As long as the materials used show no absorption, the transmission spectra are the complement of those in reflection. A characteristic feature of such ZOFs is a colour effect—e.g. colour change upon tilting and/or rotation, in particular upon rotation. Supposing a non-normal viewing angle Θ, for example Θ=30°, and grating lines parallel to the plane containing the surface normal and the viewing direction, one reflection peak can be measured which splits symmetrically into two peaks upon rotation. A well-known example of such a 90° rotation effect is a red to green colour change (one peak moves from the red to the green part of the spectrum the second peak moves from the red part to the invisible infrared part).

U.S. Pat. No. 4,484,797 describes colour filters with zero-order micro structures (ZOF), their manufacturing and their use as authenticating devices. Illuminated even with non-polarized, polychromatic light such devices show unique colour effects upon rotation and therefore can be clearly identified. As production method embossing of a thermoplastic substrate followed by a vacuum based coating are described. As waveguiding layer, ZnS is used.

US2005/0085585 describes a cross-linkable PVA and its use for the production of ophthalmic devices.

U.S. Pat. No. 6,204,202 describes porous SiO₂-layers with a refractive index between 1.10 and 1.40, which are manufactured in a sol-gel process at about 400° C.

EP 1655348 describes the manufacture of surface modified SiO₂.

EP 1464511 describes a wet coating technique capable for coating porous layers on a support, e.g. paper. Inorganic oxides, e.g. silica, in a mixture with a binder, e.g. poly(vinyl alcohol) PVA, are capable of forming layers of high porosity and thus low density. This document aims to provide improved materials for ink jet printing.

DE 10020346 describes a method to obtain a positively charged surface of silica nanoparticles using Polyaluminiumhydroxychloride.

The content of the cited references, in particular of U.S. Pat. No. 4,484,797, US2005/0085585, U.S. Pat. No. 6,204,202, EP 1464511, EP 1655348 and DE10020346 are incorporated herein by reference in its entirety.

The waveguiding layers of known ZOFs require the use of materials with a high refractive index, typically above 2.0. Inorganic materials posses such high refractive indices, while typical organic materials posses refractive indices in the range of 1.5. Such inorganic materials have disadvantages, such as high costs, incompatibility with simple manufacturing processes and the like.

Further, the known manufacturing processes for ZOFs, as described e.g. in U.S. Pat. No. 4,484,797, are regarded as slow and expensive.

Thus, it is an object of the present invention is to mitigate at least some of these drawbacks of the state of the art.

In particular, it is an aim of the present invention to provide ZOFs consisting of layers with improved and/or advantageous properties.

These objectives are achieved by a ZOF as defined in claim 1 and a manufacturing process as defined in claim 9. Further aspects of the invention are disclosed in the specification and independent claims, preferred embodiments are disclosed in the specification and the dependent claims.

Unless otherwise stated, the following definitions shall apply in this specification:

The term waveguiding layer is known in the field. To fulfill its function in a ZOF, a waveguiding layer has at least one diffractive microstructure in its surface or on its surface (c.f. FIG. 4), a refractive index typically at least 0.2 higher when compared with the adjacent layers, is substantially transparent at least in part of the visible light and has sharp interfaces to the adjacent layer(s). Substantially transparent are layers with a transmission T>50%, preferably T>90%; at least in a part of the visible spectral range. A sharp interface according to this invention is less than 200 nm thick, preferred less than 80 nm thick, particularly preferred less than 30 nm thick. Preferably, the waveguiding layer has one diffractive microstructure in one of its surfaces.

The term diffractive microstructure is known in the field. Such microstructures are characterized by the period Λ, the structure depth t, the fill factor (or duty cycle) f.f.=p/Λ and the shape of the microstructure (e.g. rectangular, sinusoidal, triangular or more complex, preferably rectangular). The period is preferably between 100 nm to 1000 nm, particularly preferably between 300 nm to 500 nm (also referred to as sub wavelength structure). Preferably the microstructures are linear or crossed gratings.

The term grating lines is known in the field. The shape of the grating lines defines the micro-structure. Typically, linear lines are used.

All values for the refractive index are determined for a wavelength of 550 nm. Unless otherwise stated, a high refractive index of a layer refers to the fact that the adjacent layer(s) has (have) a lower refractive index; and vice versa. Further, it is understood that, in line with physical principles, the minimum refractive index is 1.0. Thus, reference to a refractive index of e.g. “lower than 1.5” always implies “lower than 1.5 but at least 1.0”.

The term nanoparticles is used to designate particles having a typical diameter dₚ in the nanometer range, such as between some few nm and several 100 nm, preferably between 5 nm and 200 nm, particularly preferred between 10 nm and 60 nm. The size of the nanoparticles is determined by high-resolution imaging methods like transmission-electron-microscopy (TEM) or scanning-electron-microscopy (SEM). Preferably, the particle size distribution should be “low”; this means that preferred 90% of the particles are smaller than 2×dₚ and less than 1% of the particles are larger than 3×dₚ.

The term nanopores is used to designate pores having a typical diameter in the nanometer range, such as between some few nm and several 100 nm.

Such nanoparticles or nanopores typically have a diameter smaller than the wavelength of visible light, thereby not giving rise to scattering.

The term coating is well known in the field; it denotes a covering that is applied to an object (i.e. the substrate or layer(s) covering the substrate). They may be applied as liquids (“liquid coating”). If the liquid is a water-based solution or dispersion, the term “water based coating” is employed. Such coating techniques include dip coating, rod coating, blade coating, gravure coating, curtain or cascade coating, spray coating.

The present invention will be better understood by reference to the figures; a brief description of the figures is given below:

FIG. 1: Schematic view of a ZOF according to one embodiment of this invention with waveguiding layer 1, porous layer 2, substrate 3, covering layer 4; (Λ) period of the microstructure, (t) grating depth, (p) width of grating trough, viewing angle Θ and rotation angle φ.

FIG. 2: Schematic view of a manufacturing process of the invention. A porous layer 2 of low refractive index comprising nanoparticles is used.

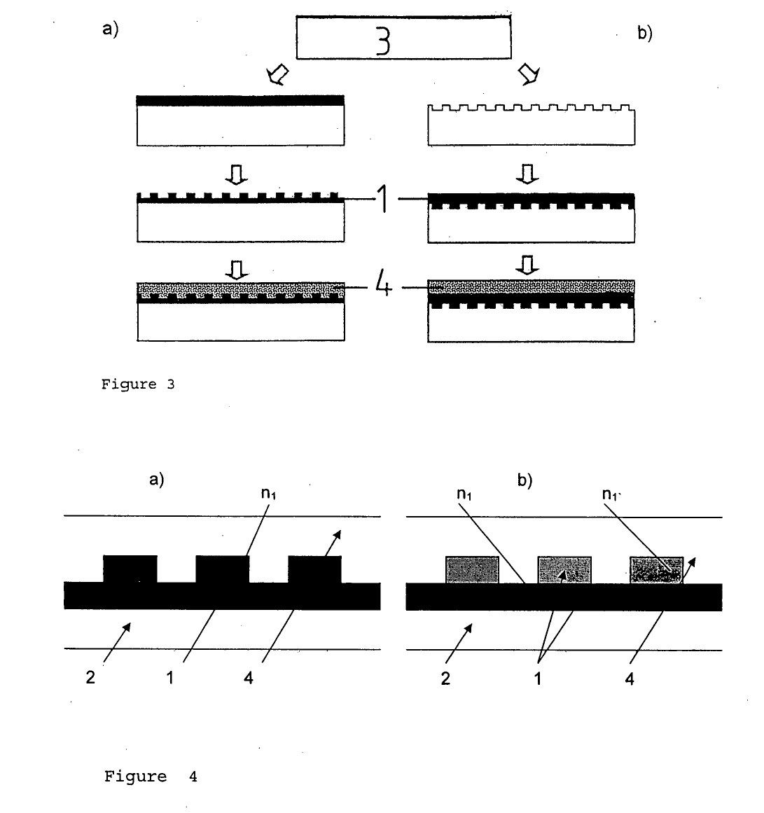

FIG. 3: Schematic view of an alternative manufacturing process of the invention. A waveguiding layer 1 of high refractive index comprising nanoparticles is used.

FIG. 4: Schematic view of a ZOF with a waveguiding layer 1 including a micro-structure in its surface (FIG. 4a)) or a micro-structure on its surface (FIG. 4b)).

The present invention will be described in more detail below. It is understood that the various embodiments, preferences and ranges as provided/disclosed in this specification may be combined at will. Further, depending of the specific embodiment, selected definitions, embodiments or ranges may not apply.

FIG. 1 shows an advantageous embodiment of a ZOF according to the present invention. It comprises a substrate 3 (only the uppermost part of which is shown in FIG. 1—normally, the thickness of the substrate exceeds the thickness of the other layers). A porous layer 2 with low index of refraction is arranged on substrate 3 and, in turn, carries the waveguiding structure 1. Waveguiding structure 1 can optionally be covered by a covering layer 4.

The pores of porous layer 2 are advantageously of sub-wavelength size to minimize optical scattering.

In more general terms, in a first aspect, the invention relates to ZOFs comprising a first layer having periodic diffractive microstructures (the “waveguiding layer” 1 of the embodiment of FIG. 1) and a second layer (the porous layer in the embodiment of FIG. 1), wherein the first layer has a refractive index higher than the second layer by at least 0.2 for obtaining waveguiding properties. Nanoparticles and/or nanopores are located in at least one of these layers, which nanoparticles and/or nanopores affect the refractive index of said at least one of said layers.

In an advantageous embodiment, the invention relates to ZOFs, wherein said two layers, namely the first and the second layer, are adjacent, thereby forming a refractive index step suitable for forming the border of a waveguiding structure.

The diffractive micro-structure referred to above is a part of the waveguiding layer. The waveguiding layer 1 either includes a micro-structure in its surface (FIG. 4a)) or includes a micro-structure on its surface (FIG. 4b)). In case of FIG. 4a) the structured and the unstructured part of the waveguiding layer have the same refractive index n₁. In case of FIG. 4b) the structured and the unstructured part of the waveguiding layer may have different refractive indices. The structured part has a refractive index n₁, while the unstructured part has a refractive index n₁, whereby n₄<n₁′<n₁ applies. The embodiment of FIG. 4a is preferred due to its simpler manufacturing.

In a further advantageous embodiment, the invention relates to ZOFs wherein at least the second layer comprises nanopores. The nanopores lead to a decrease of the average refractive index, potentially well below a typical refractive index that can be achieved by a bulk material. Advantageously, the nanopores are formed by the gaps in a layer comprising nanoparticles.

In a further advantageous embodiment, the invention relates to ZOFs, wherein at least said first layer (“waveguiding layer”) comprises nanoparticles. Nanoparticles in the first layer can be used to increase the refractive index of the same if the nanoparticles have a higher refractive index than the surrounding matrix.

In a further advantageous embodiment, the invention relates to ZOFs, comprising a substrate 3, a waveguiding layer 1 comprising nanoparticles, and optionally a covering layer 4. Such a ZOF is shown in FIGS. 3 a) and b). In this embodiment, the nanoparticles are used for increasing the index of refraction of the first layer as described in the previous paragraph.

In a further advantageous embodiment, the invention relates to ZOFs, comprising a substrate 3 having a diffractive microstructure, a waveguiding layer 1 comprising nanoparticles, and optionally a covering layer 4. Such a ZOF is shown in FIG. 3 b). In other words, in this embodiment the microstructure of the waveguiding layer is formed by the microstructure of substrate 3.

Substrate 3 is optionally releasable, i.e. it can be removed from the layer or layer stack, e.g. by breaking an adhesive bond between substrate 3 and the adjacent layer. This is particularly useful since it allows to remove the (potentially thick) substrate once that the optically active assembly of layers 1, 2 and 4 has been positioned, e.g. on a security document. Hence, in a further advantageous embodiment, the invention relates to ZOFs where the substrate is released from or releasably attached to said ZOF. Advantageously, the first layer deposited on the substrate is a release-layer and the top layer is an adhesive layer, preferably a thermo-activatable adhesive layer. Such release-layers and adhesive layers are known to the skilled person. Such released or releasable substrates are advantageous, wherein substrate and waveguiding layer are not adjacent.

The materials used and the layers manufactured for the ZOFs according to this invention are described in detail in the following. As it will become more clear throughout this specification, the nanoparticles as described herein may serve different functions: i) as a component of the porous layer to provide material with low refractive index and/or ii) as a component of the waveguiding layer to provide a material with high refractive index.

The waveguiding layer 1 is described next.

In one embodiment of this invention, the key component of the waveguiding layer is made up by water soluble, thermoplastic polymers (c.f. FIG. 2a). Examples of such polymers are selected from the group consisting of unmodified natural polymers, modified natural polymers and synthetic polymers and include: partly or completely hydrolized polyvinyl alcohol (“PVA”) or co-polymers with vinylacetate and other monomers; modified polyvinyl alcohols; homo- or co-polymers of (meth)acrylamid; poylethylenoxide (“PEO”); polyvinyl pyrrolidone (“PVP”); polyvinylacetate; stark; cellulose and its derivatives, like hydroxyethylcellulose or carboxymethylcellulose; gelatine; polyurethane PU. The aforementioned polymers can also be used as mixtures (blends), whereby preferably two of the aforementioned polymers are blended. Preferred polymers are modified PVA, polyvinylidenfluoride, PEO, copolymers of (meth)acrylamid and polyacrylnitrile or their mixtures.

PVA for example has a refractive index of about 1.50 and a glass transition temperature in the order of 85° C.

Optionally, the organic polymers as described above may be cross-linked during or after the coating process with appropriate agents. This may be done to form nearly water insoluble layers. Examples of organic cross-linking agents are aldehydes, dioxans, epoxides and reactive vinyl compounds. Inorganic cross-linking agents are for example chrome alum, aluminium alum or boric acid. Other possible agents are UV active molecules. Further, US2005/0085585 A1 describes a cross-linkable PVA and its use for the production of ophthalmic devices. The cross-linking agents mentioned for hardening the porous layer as described below are suitable likewise.

The polymers and cross-linking agents are commercially available or obtainable according to known methods.

In a further embodiment of this invention, the key component of the waveguiding layer is made up by water dispersible, thermoplastic polymer particles. These polymer particles are transformed to a continuous layer bearing the diffractive microstructure during the embossing step (illustrated in FIG. 2b). Advantageously, hydrophobic, dispersible polymer particles are used, as the waveguiding layer is not affected, e.g. swollen, by an additional coating with an aqueous solution. Thus, additional hardening of the layer after the embossing step is not necessary. Examples of suitable polymer particles are polyethylene PE, polypropylene PP, PTFE, polyamide, polyester, PU, Latex, acrylnitrile, PMMA, PS or paraffin wax, e.g. polysperse (Lawter, Belgium).

Advantageously, the size of the water dispersible, thermoplastic polymer particles is between 20 nm and 5000 nm, preferred between 40 nm and 1000 nm and particularly preferred between 50 nm and 500 nm.

Advantageously, the glass-transition temperature of the polymer particles is between 30° C. and 170° C., preferred between 50° C. and 110° C.

The polymer particles as described in this embodiment may be mixed with binders. Suitable binders are water soluble, thermoplastic polymers as mentioned above. Preferred binders are selected from the group of PVAs.

The water dispersible, thermoplastic polymer particles and binders are commercially available or obtainable according to known methods.

In a further embodiment of this invention, the key component of the waveguiding layer comprises either water dispersible, thermoplastic polymer particles or water soluble, thermoplastic polymers (as described above) and nanoparticles with a refractive index which is higher than the one of the polymer (c.f. FIG. 3). Examples of such inorganic nanoparticles are PbS, TiO₂, SiO₂, Al₂O₃ and ZrO₂. For example, Zimmermann et. al. J. Mater. Res., Vol. 8, No. 7, 1993, 1742-1748, discloses compositions comprising PbS nanoparticles and gelatine which posses refractive indices of up to 2.5. Such compositions are suitable for forming waveguiding layers. Preferably, the size of the nanoparticles is in the range of 5 nm to 200 nm, particularly preferred between 10 nm and 60 nm. Further, the particle size distribution should be low.

Typically, the microstructure is applied to the waveguiding layer. However, if the waveguiding layer comprises nanoparticles that increase the refractive index of said layer, it is possible to apply the diffractive microstructure either on or in the waveguiding layer, e.g. by embossing the waveguiding layer (c.f. FIG. 3a) or in the adjacent support, e.g. by embossing the support and coating the obtained microstructured support (c.f. FIG. 3b).

The mass thickness of the waveguiding layer is preferred in the range of 50 nm to 1000 nm, especially preferred between 100 nm and 300 nm.

The waveguiding layer as described herein may comprise additional components, such as fillers, wetting agents and the like. Such additives are known in the field and are commercially available.

Suitable parameters for the microstructured waveguiding layer are summarized below:

| | | | | | Especially | |
|---|---|---|---|---|---|---|
| | | | | | preferred | |
| Parameter | Suitable range | | Preferred range | | range | |
| period Λ | 100-1000 | nm | 300-800 | nm | 300-500 | nm |
| Thickness c * | 30-1000 | nm | 50-400 | nm | 100-300 | nm |
| depth t | 50-600 | nm | 80-400 | nm | 100-200 | nm |
| Fill factor f.f. | 0.1-0.9 | | 0.3-0.8 | | 0.4-0.7 | |
| Thickness of | less than 200 | nm | less than 80 | nm | less than 30 | nm |
| Interface | | | | | | |

* Prior to embossing

The porous layer 2 is described next. The porous layer advantageously comprises inorganic nanoparticles, preferably in combination with one or more organic binders.

Inorganic nanoparticles are preferably selected from the group consisting of metal oxides like SiO₂, Al₂O₃, AlOOH, ITO, TiO₂, ZnO₂, ZrO₂, SnO₂. Preferred nanoparticles are precipitated or pyrogenic silicon oxide and aluminium oxide or nano-crystalline aluminium-oxide/hydroxide. For example Aerosil® 200 (Degussa AG, Germany) or Cab-O-Sol® M-5 (Carbot Corporation, USA) are suitable silicon oxide nanoparticles. Examples of suitable aluminium-oxides and aluminium-hydroxide are γ-Aluminium-oxide and pseudo-bohmit respectively.

The porous layer possesses a low refractive index due to the high content of air in the porous structures. The effective refractive index n_{eff} of such layers can be approximated by a simple model based on the average refractive index of the pore matrix nₘₐₜᵣᵢₓ and the one of air weighted by the corresponding volume fraction. If vₐᵢᵣ is the pore volume than is:
n_{eff}=1×vₐᵢᵣ+nₘₐₜᵣᵢₓ(1−vₐᵢᵣ)

Thus, a suitable porous layer is obtained (refractive index is below 1.3), if the nanoparticles consist of a material with a refractive index of 1.5 and the pore volume of the porous layer is higher than 40%. A simple method to measure the pore volume is to fill the pores with a suitable solvent of known density. Based on the gain in weight of the porous layer the pore volume can be determined. Such porous layers are known. E.g., U.S. Pat. No. 6,204,202 describes porous SiO₂-layers with a refractive index between 1.10 and 1.40, which are manufactured in a sol-gel process at about 400° C.

The size of the inorganic nanoparticles, characterized by its average diameter dₚ, is in the range of 5 nm to 200 nm, preferred between 10 nm and 60 nm. Further the particle size distribution should be low. Such materials are capable of forming mechanically flexible porous layers by curtain- or cascade coating a substrate.

It is known that such nanoparticulate material forms porous structures having a high content of air in said structures. The porous layers used have a volume fraction of air of at least 20%, preferably at least 40% particularly preferred of at least 60%. Such layers are obtainable e.g. according to the methods as described in EP1464511. The meshes of the nanoparticle and the pores possess structure sizes below the micrometer range. By controlling the pore volume and the size of the structures the refractive index and the scattering properties of the layer can be tuned. Tsutsui et al (“Doubling Coupling-Out Efficiency in Organic Light-Emitting Devices Using a Thin Silica Aerogel Layer”, Adv. Mater. 13, 2001, p. 1149-1152) discloses porous layers having a refractive index of 1.03.

The porous layers according to this invention consist of 0.2 g/m² to 40 g/m², preferably 1 g/m² to 30 g/m², particular preferably 2 g/m² to 20 g/m² nanoparticles.

The thickness of the porous layer after drying is between 0.2 μm to 40 μm, preferably 1 μm to 30 μm and particular preferably 2 μm to 20 μm respectively.

In one embodiment, organic binders are added to the nanoparticles to obtain improved porous layers. Organic binders are selected from the group consisting of unmodified natural polymers, modified natural polymers and synthetic polymers and include: partly or completely hydrolized polyvinyl alcohol (“PVA”) or co-polymers with vinylacetate and other monomers; modified polyvinyl alcohols; homo- or co-polymers of (meth)acrylamid; poylethylenoxide (“PEO”); polyvinyl pyrrolidone (“PVP”); polyvinylacetate; stark; cellulose and its derivatives, like hydroxyethylcellulose or carboxymethylcellulose; cyclodextrines; gelatine; polyurethane PU. The aforementioned polymers can also be used as mixtures (blends). Preferred polymers are modified PVA, polyvinylidenfluoride, PEO, copolymers of (meth)acrylamid and polyacrylnitrile or their mixtures.

The organic binder can be cross-linked with appropriate agents to form nearly water insoluble layers. Examples of organic cross-linking agents are aldehyde, dioxans, epoxides and reactive vinyl compounds. Inorganic cross-linking agents are for example chrome alum, aluminium alum or boric acid. Other possible agents are UV active molecules. The concentration of this binder must be kept as low as possible to maintain the pore structure. On the other hand it must ensure a stable and flexible porous coating that sticks well enough to the substrate. Up to 60% binder based on the amount of nanoparticles in the layer can be used. Preferred are 0.5% to 30% and particularly preferred are 0.5% to 5% of binder.

In one embodiment, the surface of the nanoparticles may be modified to obtain a positively or negatively charged surface. A preferred method to obtain a positively charged surface of silica nanoparticles is to modify the particles with Polyaluminiumhydroxychloride as described in the DE 10020346. Such modifications can improve the rheological properties of the nanoparticle containing aqueous dispersions.

In a further embodiment, one or more salts of rare earth metals (e.g. salts of Lanthan) are added to the porous layer. The porous layer may contain 0.4 to 2.5 mol percent of said salts.

Optionally, further additives are added to the porous layer to improve its properties.

The inorganic nanoparticles, binders, rare earth salts and additives are known in the field, and are commercially available or obtainable according to known methods.

A typical pore volume of the porous layer is between 0.1 and 2.5 ml/g. Preferred are pore volumes between 0.2 and 2.5 ml/g, particularly preferred between 0.4 and 2.5 ml/g.

The nanopores of the porous layer can also be formed in a matrix that does not comprise nanoparticules, such as a foam. Gel-based processes can be used for manufacturing such layers as described e.g. in the U.S. Pat. No. 6,204,202.

The substrate 3 is described next. The substrate can be made of any material known to the skilled person in the field. The selection of the substrate depends on the intended use of the ZOF and the manufacturing process of the ZOF. Substrates may be made of glass, paper or polymer foils. Advantageously, transparent flexible polymer foils are used. Such foils may be selected from the group consisting of Cellulose esters (like Cellulosetriacetate, Celluloseacetate, Cellulosepropionate or Celluloseacetate/butyrate), Polyesters (like Polyethylen terephthalate PET or Polyethylen naphthalate PEN), Polyamides, Polycarbonates PC, Polymethyl methacrylates PMMA, Polyimides PI, Polyolefins, Polyvinylacetates, Polyethers, Polyvinylchloride PVC and Polyvinylsulfone PSU are suitable. Preferred are Polyesters, particularly Polyethylenterephthalate like Mylar® (DuPont) or Polyethylennaphthalate due to their exceptional stability. Suitable opaque flexible substrates are for example Polyolefin coated paper and white opaque Polyester like Melinex® (DuPont).

The refractive index of the substrate can e.g. be in the range of 1.35 to 1.80, but typically it is between 1.49 (PMMA) and 1.59 (PC).

The thickness of the substrate depends on the intended use of the ZOF manufactured and on the equipment used; it is preferably between 25 μm and 200 μm. In a preferred embodiment, the substrate is “flexible”; this relates to the bending properties, in particular to enable a roll-to-roll process for manufacturing a ZOF.

Optionally, the adhesion properties of the substrate may be improved by chemical or physical methods. Chemical methods include the deposition of a bonding agent, e.g. deposition of terpolymers of vinylidenchloride, acrylnitril and acrylic acid or of vinylidenchloride, methylacrylate and itaconic acid. Physical methods include plasma treatment like corona treatment.

The substrates are known in the field and are commercially available or obtainable according to known methods.

Optionally, one or more covering layers 4 may be added on top of the waveguiding layer. The covering layer can be made of any material known to the skilled person in the field. However, to keep the waveguiding properties of the polymer layer with index of refraction n₁, the covering layer has a refractive index n₄+0.2<n₁. The selection of the material for the covering layer depends on the intended use of the ZOF and the manufacturing process of the ZOF. Suitable are the polymers as described useful for manufacturing the waveguiding layer. Further, the same porous materials can be used as for the first layer (see FIG. 2).

Optionally, one or more additional layers are included to the ZOF for accommodating specific uses or needs. Such layers may be release layers or adhesive layers. Adhesive layers may be located as a top layer on the opposite site of the substrate. A release layer may be the first layer on the substrate. Such layers, their materials and production are known in the field. Preferably, the manufacture of such layers is included in the roll-to-roll process. Depending on the ZOF manufactured, such additional layers need to be transparent and may require sharp interfaces. Usually, such additional layers comprise water soluble or water dispersible polymers as defined above and additives.

In a second aspect, the invention relates to a process for manufacturing a ZOF as described herein, comprising the step of simultaneous or subsequent deposition of a substrate with said first and second layers. Preferred deposition methods are coating methods, in particular liquid coating methods.

In one embodiment, said first and second layer are deposited in two separate coating steps, preferably two separate liquid coating steps.

In a further embodiment, the invention relates to the production of ZOFs, using water based coating techniques for manufacturing of all layers required.

In a further embodiment, the invention relates to the production of ZOFs wherein all deposition steps are adapted to fit into a roll-to-roll process. The coating speed in said roll-to-roll process is typically in the range of 50 to 500 m/min, e.g. 200 m/min.

A first method suitable for low costs roll-to-roll mass production of ZOF as described herein is illustrated in FIGS. 2a and 2b. In brief, the process comprises at least two water based coating steps followed by an embossing step and optional further deposition, drying and/or cross-linking steps. First, on a flexible and transparent or opaque substrate 3 with a refractive index 1.35<n_{substrate}<1.80 a porous layer with a refractive index n₂+0.2<n_{substrate} is deposited from an aqueous, inorganic nanoparticles containing dispersion by a water based coating technique. Optionally, an organic binder or other additives are added to the dispersion. The porous layer obtained is dried e.g. by air fans, infrared radiation or microwave radiation. The drying is done preferred in an air flow with a temperature below 60° C. Preferably, the drying is done immediately after deposition. Next, a polymer layer with a refractive index n₁ at least 0.2 higher than that of the porous layer is deposited on the porous layer. This polymer layer acts as an optical waveguide (waveguiding layer). The deposition is done by a water based coating technique. In FIG. 2a, deposition of a water-soluble polymer is depicted, while FIG. 2b depicts the deposition with a water-dispersible polymer. The polymer layer is dried after the deposition. If the restriction concerning the indices of refraction, the layer thickness and the sharpness of the interface are fulfilled, thin film interference effects are visible or measurable. This effect may serve as a quality control. Next, diffractive microstructures are embossed in the polymer layer with an embossing tool, e.g. a nickel shim. The embossing can be done at elevated temperature and/or with UV-illumination (“hot”- and “UV”-embossing). Typically hot-embossing is done at a temperature above the glass transition temperature of the polymer layer. Optionally, a hardening of the polymer layer is useful. It is believed that such hardening protects the embossed microstructures from deterioration by swelling of the polymer layer during additional coating steps. The polymer chains are cross-linked by chemical treatment, thermal treatment or irradiation, (e.g. UV irradiation) to enhance the stability of this layer against solvents (like water) and/or mechanical stress. This can be realised by incorporating appropriate additives in the waveguiding layer or by covalently linking cross-linkable groups to the polymer. The cross linking is preferably done during or after the embossing step. It is believed that cross-linking prevents swelling of the micro-structured waveguide layer upon the deposition of additional layers. If a UV-curable material is used for the polymer layer which keeps the microstructure for a short while after the embossing tool is removed the hardening by UV-illumination can be done separately from the embossing step, e.g. in an adjacent unit of the roll-to-roll machine. This reduces the complexity of the machine and therefore the investment cost. If a thermal cross-linking material is used for cross-linking the polymer layer and provided the hot embossing is done at sufficient high temperatures, the cross-linking can be achieved already during the embossing step. Thus, no separate cross-linking step is needed.

Some water based coating techniques are capable of coating several layers simultaneously. However, the coating of the low and the high refractive index layer (first and second layer as defined above) in two steps is preferred. The two step process usually results in a sharper interface between the porous and the polymer layer. Without being bound to theory, it is believed that a sharp interface between the layers is important to ensure a sufficient waveguiding of the incident light in the polymer layer.

The deposition referred to above may be accomplished by any method known to the expert. Preferably, deposition is accomplished by coating techniques, in particular by water based coating techniques. Such techniques include dip coating, rod coating, blade coating, gravure coating, spray coating, curtain coating or cascade coating; particular preferred techniques are curtain coating and cascade coating.

Optionally, one or more, preferably one, additional covering layer(s) 4, having a refractive index n₄<n₁−0.2, is (are) deposited on the obtained layer stack. Details on covering layer 4 are given above. Suitable deposition methods are described previously in context with manufacturing the first and second layer and suitable thickness range for the covering layer is the same as for the first porous layer.

To obtain a flat surface which can be used to laminate the ZOF to other substrates, a further additional polymer layer can be deposited (not shown in FIG. 2). If this layer has no waveguiding function the interface to the covering layer 4 needs not to be very sharp. Thus, the covering layer and this further polymer layer can be coated in one run which reduces the production costs.

A further method suitable for low costs roll-to-roll mass production of ZOF as described herein is illustrated in FIG. 3. In short, this method consists of at least one water based coating step and one embossing step. The embossing can be done prior to the coating step(s) (FIG. 3b) or after coating the waveguiding layer (FIG. 3a). Optional, additional coating steps are possible. The coating speed in said roll-to-roll process is typically in the range of 50 to 500 m/min, e.g. 200 m/min.

Referring to FIG. 3a, on a flexible and transparent or opaque substrate with an refractive index n_{substrate} between 1.35 and 1.80 a polymer layer (waveguiding layer) with an refractive index n₁>n_{substrate}+0.2 is deposited from aqueous solution or aqueous dispersion, e.g. by a water based coating technique. The thickness of the polymer layer, which acts a waveguide, is in the range of 50 nm to 1000 nm, preferred between 100 nm and 300 nm. It is dried after deposition, preferably immediately after deposition. Next, the diffractive microstructure needed for the function of the ZOF is embossed in the polymer layer as described above. To enhance the stability of this layer against solvents and/or mechanical stress the polymer chains can be cross-linked as described above. Optionally, an additional covering layer may be deposited as a protective top coat by water based coating technique. This layer can be a porous or a polymer layer. This layer must posses a refractive index n₄ which is distinctly lower than the one of the adjacent polymer layer 1. At least n₄<n₁−0.2 must be fulfilled. The details relating to the layer and its manufacture are given above. The same considerations to the optional further polymeric top coat are applicable likewise.

Referring to FIG. 3b, the embossing step is done first. Thus, the diffractive microstructure is embossed, preferred hot-embossed, in the substrate (or in an embossable layer deposited on the substrate). Next, the polymer layer (waveguiding layer) is coated on the microstructured substrate by a water based coating technique. The same considerations regarding the indices of refraction of all layers are applicable as in the method as described above for FIG. 3a. Depending a) on the viscosity of the aqueous solution or dispersion, b) the dried layer thickness and c) the depth of the microstructure, the top surface of the polymer layer is flat (FIG. 3b) or possess a grating structure correlated to the structure of the substrate (not shown in FIG. 3). Optionally, on top of the waveguiding layer an additional covering layer with refractive index 0.2 lower than the one of the waveguiding layer may be coated. One function of this porous (or polymer) layer is, to protect the waveguiding layer. Optionally, an additional polymer top coat (not shown) may be deposited as described before. The possible materials for the substrate and the layers are the same as described in the context of FIG. 3a.

In yet another embodiment a stack of alternating layers with high and low refractive index is deposited by water based coating techniques, whereas the high refractive index layers act as optical waveguides and are embossed with the zero-order microstructure.

In one embodiment of both production methods, as shown in FIGS. 2 and 3, the coated and micro-structured foil (i.e. the manufactured ZOF) is used to manufacture adhesive tags or labels bearing the colour effect of the ZOF. For this purpose, the uncoated side of the substrate or the top coat of the layer stack is provided with an adhesive layer and a removable carrier protecting the adhesive layer. The latter can be for example silicon coated paper or polymeric foil. Then the substrate with the coated layer stack is sliced such that tags or labels of the desired size can be stripped of the carrier and applied to products, packages and the like. The known techniques of labelling tags with additional information like batch number, company logo and the like can be applied to the foil manufactured according to the invention.

In another embodiment of both production methods, as shown in FIGS. 2 and 3, one additional release layer is deposited between the substrate and the first coated layer and one additional adhesive layer (such as a thermo-activateable adhesive layer) is deposited as top layer.

This enables a separation of the coated layer stack from the substrate and to transfer the obtained ZOF. With this method, it is possible to manufacture a ZOF that is transferable to the surface of another device such as a package, banknote, security device, e.g. by a lamination process or a hot stamping process. A ZOF according to this embodiment is distinctly thinner compared to a ZOF which is glued with an adhesive to a product or a package and the like according to the embodiment described before.

In a further embodiment, the invention provides a manufacturing process for ZOFs using roll-to-roll water based coating techniques and embossing techniques. This provides a process that is environmentally friendly, simple and fast, as hazardous solvents are avoided for coating and structuring. Further no expensive vacuum processes are needed.

In an advantageous embodiment, the present invention provides methods of mass-producing such ZOFs using hot- or UV-embossing. Again, this provides a process that is environmentally friendly, simple and fast. Further such a process, that is compatible with standard equipment, is reliable and also reduces investment costs.

In an advantageous embodiment, the present invention provides methods of mass-producing such ZOFs using hot-embossing, whereby the embossing temperature is above the glass transition temperature of the embossed polymer

In a further advantageous embodiment, the present invention provides methods of mass-production of ZOFs using curtain or cascade coating techniques. This provides a process that is compatible with standard equipment, is reliable and reduces investment costs.

In a further embodiment, the ZOF according to this invention are manufactured by a roll-to-roll production comprising the steps of:
depositing on a flexible substrate a first porous layer with an refractive index n₂ by a water based coating technique and
depositing a first polymer layer with refractive index n₁>n₂+0.2 on top of the first porous layer by a water based coating technique
forming, e.g. by embossing, a zero-order diffractive micro-structure in the first polymer layer (whereas the obtained polymer layer acts as an optical waveguide) and
optionally depositing an additional second porous layer with refractive index n₄<n₁−0.2 on top of the first micro-structured polymer layer by a water based coating technique.

In a further embodiment, the ZOF according to this invention are manufactured by a roll-to-roll production comprising the steps of:
depositing on a flexible substrate with an refractive index between 1.35 and 1.80 a first polymer layer with an refractive index n₁ at least 0.2 higher than the refractive index of the flexible substrate by a water based coating technique (whereas this first polymer layer acts as an optical waveguide) and
forming, advantageously by embossing, a zero-order diffractive micro-structure in this first polymer layer and
optionally depositing a first porous layer or an second polymer layer with refractive index n₄<n₁−0.2 on top of the first micro-structured polymer layer by a water based coating technique.

In a further embodiment, the ZOFs according to this invention are manufactured by a roll-to-roll production comprising the steps of:
forming, advantageously by embossing, a zero-order diffractive micro-structure in a flexible substrate with an refractive index between 1.35 and 1.80 and
depositing a first polymer layer with an refractive index n₁ at least 0.2 higher than the refractive index of the flexible substrate by a water based coating technique (whereas said first polymer layer acts as an optical waveguide) and
optionally depositing a first porous layer or an second polymer layer with refractive index n₄<n₁−0.2 on top of the first micro-structured polymer layer by a water based coating technique.

In a third aspect, the invention relates to the use of ZOFs, as described herein, as security devices in the fields of authentication, identification and security in a variety of devices like (but not restricted to) banknotes, credit cards, passports, tickets, document security, anti-counterfeiting, brand protection and the like. Another field of use for such ZOFs, taking the benefit of its colour effects, are marketing devices, e.g. in the applications adhesive labels, product packaging and the like.

Without further coatings 4 the waveguiding layer is located at the surface of the coated substrate (with air as the second adjacent material to the waveguiding polymer layer). Such a ZOF is sensitive to touch and other mechanical stress. This can be used e.g. either to visualise if and where packages were touched and/or for marketing purposes. Further, it prevents that packages can be reused several times. This is important for example to suppress illegal re-import of products like pharmaceuticals which are often repacked in used packages.

However, for most applications, additional protective coatings are useful and are thus preferred. An additional function of the covering layer is to hamper attempts to analyse the diffractive microstructure.

In a further embodiment, the present invention provides ZOFs, as described herein, which are in the form of hot or cold transferable labels, adhesive tags, and the like.

In a further embodiment, the present invention provides ZOFs, as described herein, wherein the substrate 3 is made of paper.

In a further aspect, the present invention relates to the use of inorganic nanoparticles in the manufacture of a ZOF as described herein.

In one embodiment, the present invention relates to the use of inorganic nanoparticles for forming layers having a low refractive index; in particular in forming porous layers.

In a further embodiment, the present invention relates to the use of inorganic nanoparticles for forming layers having a high refractive index; in particular in forming waveguiding layers.

To further illustrate the invention, the following examples are provided. These examples are provided with no intend to limit the scope of the invention.

### EXAMPLES

### Example 1

A first layer was deposited by curtain coating on a transparent PET substrate with a thickness of about 200 μm. The employed solution had a composition as described in table 2. After drying, the thickness of the first layer is approximately 8 μm. The surface modified SiO₂ is obtained according to ex. 1 of EP 1655348.

Next, a second layer was curtain coated in a second coating step from a solution according to table 3. The dried layer thickness is about 200 nm to 240 nm. Blue to violet interference colours are visible, which are believed to be due to the differences in the refractive index of both layers, the sharp interface between both layers and the adequate polymer layer thickness.

Next, a linear grating structure with a period of 365 nm, a grating depth of 100 nm and a rectangular grating profile was hot embossed in the second layer at 110° C.

All coating steps took place in a continuous roll-to-roll process using a curtain coating machine.

Viewed at an angle of Θ=30° the obtained ZOF shows a pronounced colour change from blue to red upon rotation by 90°.

TABLE 2
First layer (Low refractive index, porous)

| | amount |
|---|---|
| component | [g/m2] |
| Surface modified SiO2 | 6.000 |
| Polyvinyl alcohol, Mowiol 40-88, Omya AG, Switzerland | 1.300 |
| Hardener, Boric acid, Schweizerhall Chemie AG, Switzerland | 0.229 |
| total (solid) | 7.529 |
| Water | 40.284 |
| Total (solution) | 47.529 |

TABLE 3
Second Layer (High refractive index)

| | amount |
|---|---|
| component | [g/m2] |
| Polyvinylalkohol Mowiol 56-98, Omya AG, Switzerland | 0.240 |
| Total (solid) | 0.276 |
| Water | 32.724 |
| Total (solution) | 32.964 |

### Example 2

A first layer was deposited by curtain coating on a transparent PET substrate with a thickness of about 200 μm. The employed solution had a composition as described in table 4. The surface modified SiO₂ is obtained according to ex. 1 of EP 1655348.

Next, a second layer including polymer particles was curtain coated in a second coating step from a solution according to table 5.

Next, a linear grating structure with a period of 365 nm, a grating depth of 100 nm and a rectangular grating profile was hot embossed in the second layer at 80° C.

All coating steps took place in a continuous roll-to-roll process using a curtain coating machine.

Viewed at an angle of Θ=30° the obtained ZOF shows a pronounced colour change from blue to green upon rotation by 90°.

TABLE 4
First layer (Low refractive index, porous)

| | amount |
|---|---|
| component | [g/m2] |
| Surface modified SiO2 | 21.052 |
| Polyvinyl alcohol, Mowiol 40-88, Omya AG, Switzerland | 4.928 |
| Hardener, Boric acid, Schweizerhall Chemie AG, Switzerland | 0.8 |
| total (solid) | 26.78 |
| Water | 157.3 |
| Total (solution) | 184.08 |

TABLE 5
Second Layer (High refractive index)

| | amount |
|---|---|
| component | [g/m2] |
| Polyvinyl alcohol GOHSEFIMER K-210, Nippon Synthetic | 0.07 |
| Chemical Industry Ltd., Japan | |
| Latex Jonrez E2001, MeadVasco Corporation, USA | 0.93 |
| Total (solid) | 1.00 |
| Water | 23.964 |
| Total (solution) | 24.964 |

1. Zero-order diffractive filter comprising a first layer having periodic diffractive microstructures and a second layer, wherein said first layer has a refractive index higher than said second layer by at least 0.2, and nanoparticles and/or nanopores are located in at least one of said layers which affect the refractive index of at least one of said layers.

2. Filter of claim 1, wherein at least said second layer comprises nanoparticles and/or nanopores.

3. Filter according to claim 1, wherein at least said first layer comprises nanoparticles.

4. Filter according to claim 1, wherein said two layers are adjacent.

5. Filter according to claim 1, comprising
a substrate which is optionally releasable,
a porous layer comprising nanopores,
a waveguiding layer, and
optionally a covering layer.

6. Filter according to claim 1, comprising
a substrate,
a waveguiding layer comprising nanoparticles, and
optionally a covering layer.

7. Filter according to claim 6, comprising a substrate having a diffractive microstructure.

8. Filter according to claim 1, wherein the substrate is releasable attached.

9. Process for manufacturing a filter according to claim 1 comprising the step of simultaneous or subsequent deposition on a substrate of said layers.

10. Process for manufacturing a filter according to claim 1 comprising the steps of:
depositing on a flexible substrate a first porous layer with an refractive index n₂ by a water based coating technique and
depositing a first polymer layer with refractive index n₁>n₂+0.2 on top of the first porous layer by a water based coating technique
forming a zero-order diffractive micro-structure in the first polymer layer, and
optionally depositing an additional covering layer with refractive index n₄<n₁−0.2 on top of the first micro-structured polymer layer by a water based coating technique.

11. Process of claim 10 wherein said first porous layer comprises nanopores formed by an assembly of nanoparticles.

12. Process for manufacturing a filter according to claim 1 comprising the steps of:
depositing on a flexible substrate with an refractive index between 1.35 and 1.80 a first polymer layer with an refractive index n₁ at least 0.2 higher than the refractive index of the flexible substrate by a water based coating technique, whereas this first polymer layer acts as an optical waveguide and
forming a zero-order diffractive micro-structure in this first polymer layer and
optionally depositing an additional covering layer with refractive index n₄<n₁−0.2 on top of the first micro-structured polymer layer by a water based coating technique.

13. Process for manufacturing a filter according to claim 1 comprising the steps of:
forming a zero-order diffractive micro-structure in a flexible substrate with an refractive index between 1.35 and 1.80 and
depositing a first polymer layer with an refractive index n₁ at least 0.2 higher than the refractive index of the flexible substrate by a water based coating technique, whereas said first polymer layer acts as an optical waveguide and
optionally depositing an additional covering layer with refractive index n₄<n₁−0.2 on top of the first micro-structured polymer layer by a water based coating technique.

14. Process of claim 10 wherein said zero-order diffractive micro-structure is formed by embossing.

15. Process according to claim 10 wherein all deposition steps are part of a roll-to-roll process.

16. Filter, obtained by a process according to claim 9.

17. Use of a filter according to claim 1 for manufacturing of an authentication-, identification- or security device selected from the group comprising banknotes, credit cards, passports, tickets.

18. Use of a filter according to claim 1 for manufacturing of a marketing device selected from the group comprising adhesive labels and product packaging.

19. Use of inorganic nanoparticles in the manufacture of a filter according to claim 1.
